(19) United States
(12) Patent Application Publication
(10) Pub. No.: US 2016/0108729 A1
(43) Pub. Date: Apr. 21, 2016

(54) METHOD AND DEVICE FOR THE CONCURRENT DETERMINATION OF FLUID DENSITY AND VISCOSITY IN-SITU

(71) Applicants: Li GAO, Katy, TX (US); Michael T. PELLETIER, Houston, TX (US); James MASINO, Houston, TX (US); Mark Anton PROETT, Missouri City, TX (US); HALLIBURTON ENERGY SERVICES, INC., Houston, TX (US)

(72) Inventors: Gao Li, Katy (US); Michael T. Pelletier, Houston, TX (US); Mark Anton Proett, Houston, TX (US); James Masino, Houston, TX (US)

(21) Appl. No.: 14/889,955

(22) PCT Filed: Jul. 24, 2013
(86) PCT No.: PCT/US13/51861

§ 371 Date: Nov. 9, 2015

(51) Int. Cl. E21B 49/08; G01N 11/16; G01N 9/00

(52) U.S. Cl. CPC E21B 49/081; G01N 9/002; G01N 11/16; E21B 2049/085

(57) ABSTRACT

A measurement device and method for determining the density and viscosity of a fluid in a downhole environment from vibration frequencies of a sample cavity.

### FIELD OF THE INVENTION

The present invention generally relates to the analysis of downhole fluids in a geological formation. More particularly, the present invention relates to a method and apparatus for determining fluid viscosity downhole in a borehole.

### BACKGROUND OF THE INVENTION

While this application is written primarily about the application of technology in a hydrocarbon producing well, the techniques described herein have application in other environments, including chemical processing, waste water treatment, and food processing, etc.

Hydrocarbon producing wells may contain different formation liquids, such as mixtures of water, gaseous hydrocarbons and fluid hydrocarbons, each having different physical properties. In order to evaluate the commercial value of a hydrocarbon producing well, it is useful to obtain information by understanding and analyzing the physical properties of the formation fluid(s) of the hydrocarbon producing well.

Physical properties of formation fluid(s) present in a hydrocarbon producing well are typically obtained using downhole tools, such as wireline tools and logging while drilling (LWD) tools, as well as any other tool capable of being used in a downhole environment. In wireline measurements, a downhole tool, or logging tool, can be lowered into an open wellbore on a wireline. Once lowered to the depth of interest the measurements can be taken. LWD tools take measurements in much the same way as wireline-logging tools, except that the measurements are typically taken by a self-contained tool near the bottom of the bottomhole assembly and are recorded downward, as the well is deepened, rather than upward from the bottom of the hole as wireline logs are recorded.

One of the important physical properties of formation fluid is its density. The density of a formation fluid can help identify the type of fluid (gas, oil or water) present in the formation. Another important physical property of formation fluid is its viscosity, which may directly affect the producibility and the economic viability of a well. Typically, density is measured by using a density sensor located on a downhole tool, such as a wireline tool or LWD tool, and fluid viscosity is typically obtained from a separate viscosity sensor. It is desirable to directly measure and determine simultaneously both density and viscosity of formation fluids.

### BRIEF DESCRIPTION OF DRAWINGS

FIG. 1 shows one embodiment of a densitometer according to the present invention.

FIG. 2 shows another embodiment of a densitometer according to the present invention.

FIG. 3 shows one embodiment of the receiver and transmitter arrangements in accordance with the present invention.

FIG. 3A is an electrical schematic depicting one embodiment of the receiver arrangement in accordance with the present invention.

FIG. 4 shows an exemplary measurement module.

FIG. 5 shows a graph of an exemplary resonance peak.

FIG. 6 shows a method for adaptive tracking of a resonance frequency.

FIG. 7 shows a graph of a measured density as a function of time.

FIG. 8 shows a method for measuring resonance peak frequency, amplitude, and width.

FIG. 9 shows a pressure-time profile used in assessing the accuracy of the fluid density measurement technique.

FIG. 10 shows the result of the assessment of the accuracy of the fluid density measurement technique.

FIGS. 11 and 12 are flow charts.

FIG. 13 illustrates a numerical solution.

FIG. 14 illustrates the deflection of a cantilever hanging under its own weight.

FIG. 15 shows a test setup.

FIG. 16 illustrates the measured deflection of the cantilever illustrated in FIG. 15.

FIG. 17 shows experimental data.

FIGS. 18 and 19 show analysis of the experimental data.

FIG. 20 shows an embodiment of a technique for solving the frequency equation.

FIGS. 21-23 show techniques for obtaining the temperature dependent Young's modulus.

FIG. 24 shows an example of the time-domain response of the vibrating tube density sensor.

FIG. 25 shows an example of measuring the frequency response of the sensor.

FIG. 26 shows measured Q values versus viscosity for these fluids using different excitations.

FIG. 27 shows Q values divided by density versus viscosity for the example fluids.

FIG. 28 shows Q/p versus the inverse square root of density-viscosity product for the example fluids.

FIG. 29 shows decay time constant versus the inverse square root of the density-viscosity product for the example fluids.

FIG. 30 shows viscosity determined according to the invention versus actual viscosity.

FIG. 31 is a flow chart.

FIG. 32 is a block diagram.

FIG. 33 shows a time domain decaying vibratory signal having an envelope obtained using a Hilbert transform and a logarithmic plot of the envelope, wherein the slope is −1/τ.

### DETAILED DESCRIPTION

The present invention relates to a method of directly measuring the resonance frequency and resonance quality factor (Q) in a vibrating tube density sensor and using the measured resonance frequency to calculate fluid density and the measured Q value and calculated density to calculate viscosity. The present invention also includes a downhole tool that can be used to directly measure Q and density in a downhole environment.

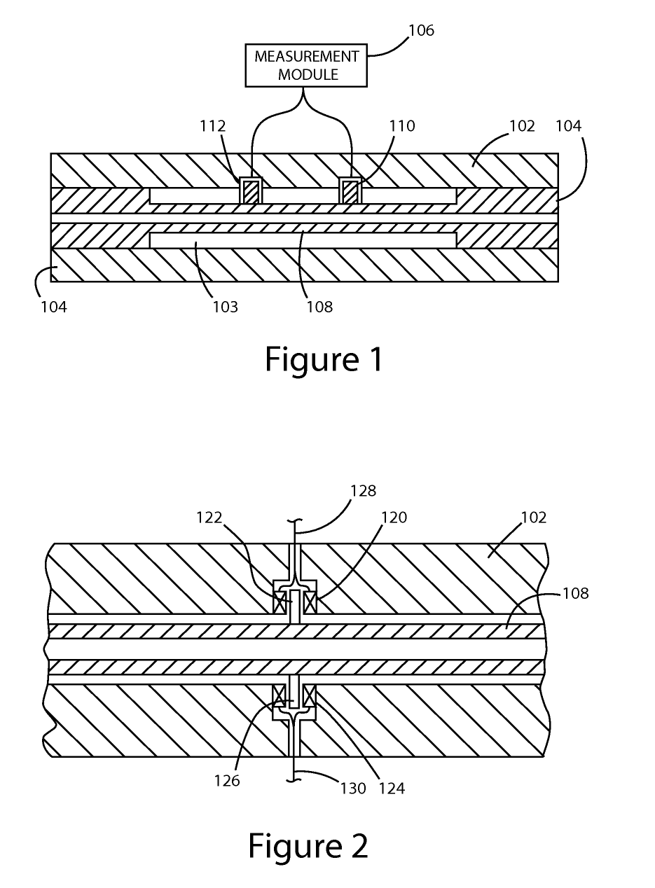

Referring now to FIG. 1, one embodiment for measuring density and viscosity of a flowing fluid, generally includes a rigid housing 102, two bulkheads 104, a flow tube 108, a vibration source 110, a vibration detector 112, and a measurement module 106. The rigid housing 102 surrounds and protects a volume 103 through which the flow tube 108 passes and reduces the response to vibrations not associated with particular vibratory modes of the flow tube 108. The bulkheads 104 seal the volume and secure the flow tube 108 within that volume. The volume 103 preferably contains air, a vacuum or relatively inert gas such as nitrogen or argon. If gases are used, then they are preferably at atmospheric pressure when the device is at room temperature.

The rigid housing 102, bulkheads 104, and flow tube 108 are preferably made from material in a configuration that can withstand pressures of more than 20,000 psi (pounds per square inch) at temperatures of 250° C. or more. Two examples of suitable materials are Titanium and Hastaloy-HA276C. Preferably, the bulkheads 104 and the flow tube 108 are constructed from the same piece of material, with bulkheads 104 being regions of larger diameter on either end of the tube 108. Alternatively, the flow tube 108 may be welded to the bulkheads 104, or otherwise attached. The flow tube 108 may also be secured to the rigid housing 102. Preferably, the rigid housing 102, bulkheads 104, and the flow tube 108 are constructed from the same material in order to alleviate thermally induced stresses when the system is in thermal equilibrium.

The flow tube 108 is preferably straight, as this reduces any tendencies for plugging and erosion by materials passing through the flow tube 108. However, it is recognized that bent tubes of various shapes, including “U”-shaped tubes, may also be applicable.

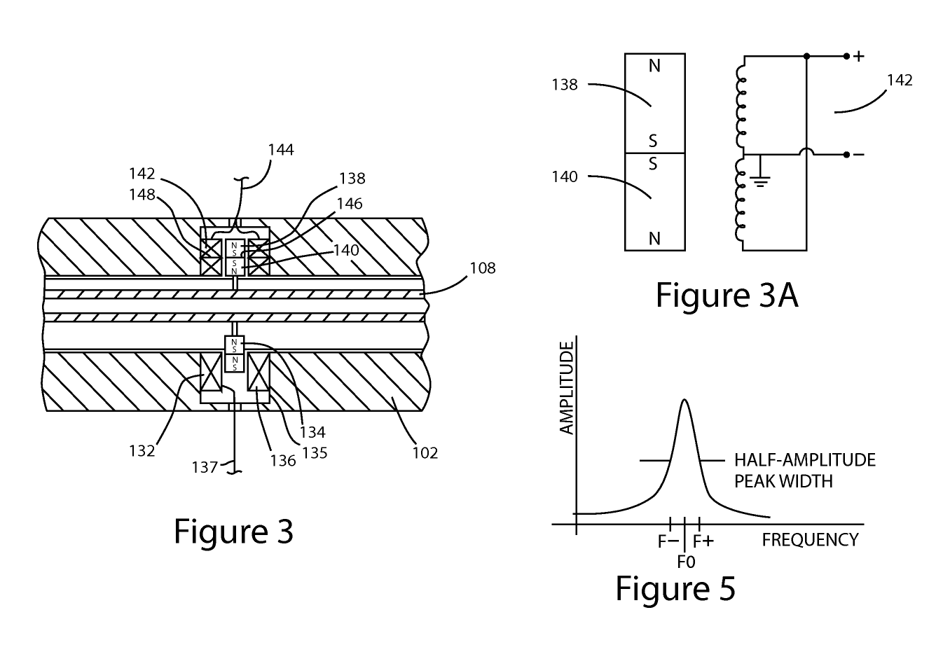

As described above, attached to the flow tube 108 are a vibration source 110 and a vibration detector 112. The vibration source 110 and vibration detector 112 may be located side by side as shown in FIG. 1 or, alternatively located on opposite sides of the flow tube 108 at a point half way between the bulkheads 104, as shown in FIGS. 2 and 3. Other source/detector configurations are also contemplated. The vibration source 110 can include any means capable of exciting the flow tube 108 into one or more of its resonance modes.

Now referring to FIG. 2, one embodiment of the present invention is illustrated containing a flow tube 108, two coils 120, 124 connected to the housing 102, and two magnetic rods 122, 126 connected to the flow tube 108. The coils 120, 124 may also incorporate a ferrous core to form a more effective electromagnet. One coil 120 is connected by electrical leads 128 to a transmitter (not shown). Application of an alternating current to the coil 120 exerts an electromagnetic force on the rod 122, which causes the rod 122 to translate linearly, therefore imparting a vibration on the tube 108. The other coil 124 is connected by leads 130 to a receiver (not shown). The vibration in the tube 108 moves the rod 126 within the coil 124, therefore creating a voltage to generate at the leads 130 that is monitored by the receiver.

Now referring to FIG. 3, a vibration source 132 is illustrated, including a magnet 134 (magnet 134 may include one or more magnets as shown in FIG. 3) secured to the flow tube 108, and a single coil winding 136 secured to the housing 102. The coil 136 is connected by leads 137 to a transmitter (not shown). The coil 136 is mounted toward the outer extreme of the magnet 134 (this is exaggerated in the figure for clarity). The precise mounting location of the coil 136 is empirically determined by maximizing the vibration force imparted upon the flow tube 108. Applying an alternating current to the coil 136 causes a resulting electromagnetic force that vibrates the flow tube 108.

Still in reference to FIG. 3, an embodiment of the vibration detector is illustrated containing two magnets 138, 140 secured to the vibrating flow tube 108, and a dual coil winding 142 secured to the housing 102. The dual coil 142 is connected by leads 144 to a receiver (not shown). The symmetry axes of the magnets 138, 140 and dual coil 142 are aligned and the magnets 138, 140 are arranged such that their magnetic fields repel. The dual coil 142 may be composed of two identical coils mounted end-to-end with symmetry axes aligned and electrically connected. A schematic of the dual coil 142 is presented in FIG. 3A. The plane 146 defined by the interface of the magnets 138, 140 is aligned with plane 148 defined by the intersection of the opposing coil windings of the dual coil 142 as shown in FIG. 3. The coils are connected so as to be phased in such a way that minimal or no voltage is generated at the leads 144 if the coils are placed in a uniform magnetic field (such as that induced by current flow in the nearby vibration source). However, the coils do respond to movement of the opposed magnet pair. Applying a vibration to the flow tube 108 causes a voltage to generate at the leads 144 of the dual coil 142.

The unique arrangement of the vibration detector magnets 138, 140 acts to minimize the magnetic field created by the vibration detector as well as the effects of the magnetic field created by the vibration source. The net effect of this arrangement is to decrease the interference created in the signal produced by the vibration detector, which allows variations in the vibration of the flow tube 108 to be more accurately and reliably detected.

It is noted that in both embodiments, the vibration sources and vibration detectors can be mounted near an antinode (point of maximum displacement from the equilibrium position) of the mode of vibration they are intended to excite and monitor. It is contemplated that more than one mode of vibration may be employed (e.g. the vibration source may switch between multiple frequencies to obtain information from higher resonance harmonic frequencies). The vibration sources and detectors can be positioned so as to be near antinodes for each of the vibration modes of interest.

It will be understood that the techniques described below may be used with vibration sources and vibration sensors other than those illustrated in FIGS. 1-3.

### Measurement Module for Determining Density

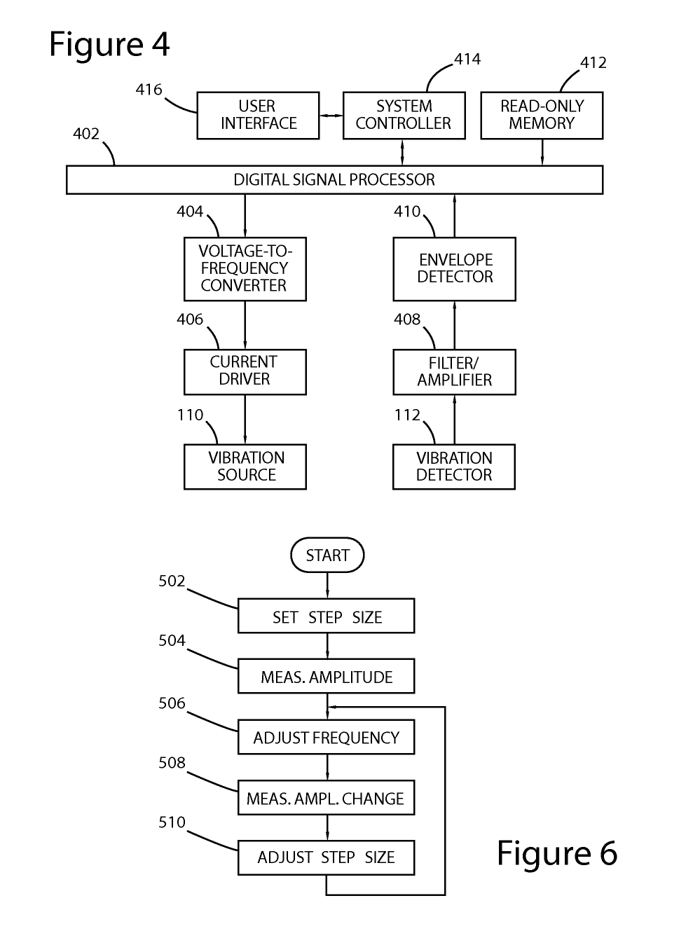

Referring now to FIG. 4, one embodiment of the measurement module generally includes a digital signal processor 402, voltage-to-frequency converter 404, current driver 406, filter/amplifier 408, amplitude detector 410, and a read-only memory (ROM) 412. The digital signal processor 402 may be configured and controlled by a system controller 414 that operates in response to actions of the user on the user interface 416. The system controller 414 preferably also retrieves measurements from the digital signal processor 402 and provides them to the user interface 416 for display to the user.

The digital signal processor 402 can execute a set of software instructions stored in ROM 412. Typically, configuration parameters are provided by the software programmer so that some aspects of the digital signal processor's operation can be customized by the user via interface 416 and system controller 414. The set of software instructions can cause the digital signal processor 402 to perform density measurements according to one or more of the methods detailed further below. The digital signal processor can include digital to analog (D/A) and analog to digital (A/D) conversion circuitry for providing and receiving analog signals to off-chip components. Generally, most on-chip operations by the digital signal processor are performed on digital signals.

In performing one of the methods described further below, the digital signal processor 402 provides a voltage signal to the voltage-to-frequency converter 404. The voltage-to-frequency converter 404 produces a frequency signal having a frequency proportional to the input voltage. The current driver 406 receives this frequency signal and amplifies it to drive the vibration source 110. The vibration source 110 causes the flow tube to vibrate, and the vibrations are detected by vibration detector 112. A filter/amplifier 408 receives the detection signal from vibration detector 112 and provides some filtering and amplification of the detection signal before passing the detection signal to the amplitude detector 410. The filter/amplifier 408 serves to isolate the vibration detector 112 from the amplitude detector 410 to prevent the amplitude detector 410 from electrically loading the vibration detector 112 and thereby adversely affecting the detection sensitivity. The amplitude detector 410 produces a voltage signal indicative of the amplitude of the detection signal. The digital signal processor 402 measures this voltage signal, and is thereby able to determine the vibration amplitude for the chosen vibration frequency.

The measurement module employs the vibration source 110 and vibration detector 112 to locate and characterize the resonance frequencies of the flow tube 108. Several different methods are contemplated and non-limiting examples are given herein. In a first method, the measurement module causes the vibration source 110 to perform a frequency “sweep” across the range of interest, and record the amplitude readings from the vibration detector 112 as a function of the frequency. As shown in FIG. 5, a plot of the vibration amplitude versus frequency will show a peak at the resonance frequency f₀. The resonance frequency can be converted to a density measurement, and the shape of the peak may yield additional information such as viscosity and multiple phase information.

In a second method, the measurement module adaptively tracks the resonance frequency using a feedback control technique. One implementation of this method is shown in FIG. 6. An initial step size for changing the frequency is chosen in block 502. This step size can be positive or negative, to respectively increase or decrease the frequency. In block 504, the vibration source is activated and an initial amplitude measurement is made. In block 506, the vibration frequency is adjusted by an amount determined by the step size. In block 508, a measurement of the amplitude at the new frequency is made, and from this, an estimate of the derivative can be made. The derivative may be estimated to be the change in amplitude divided by the change in frequency, but the estimate preferably includes some filtering to reduce the effect of measurement noise. From this estimated derivative, a distance and direction to the resonance peak can be estimated. For example, if the derivative is large and positive, then referring to FIG. 5 it becomes clear that the current frequency is less than the resonance frequency, but the resonance frequency is nearby. For small derivatives, if the sign of the derivative is changing regularly, then the current frequency is very near the resonance frequency. For small negative derivatives without any changes of sign between iterations, the current frequency is much higher than the resonance frequency. Returning to FIG. 6, this information is used to adjust the step size in block 510, and the digital signal processor 402 returns to block 506. This method may work best for providing a fast measurement response to changing fluid densities.

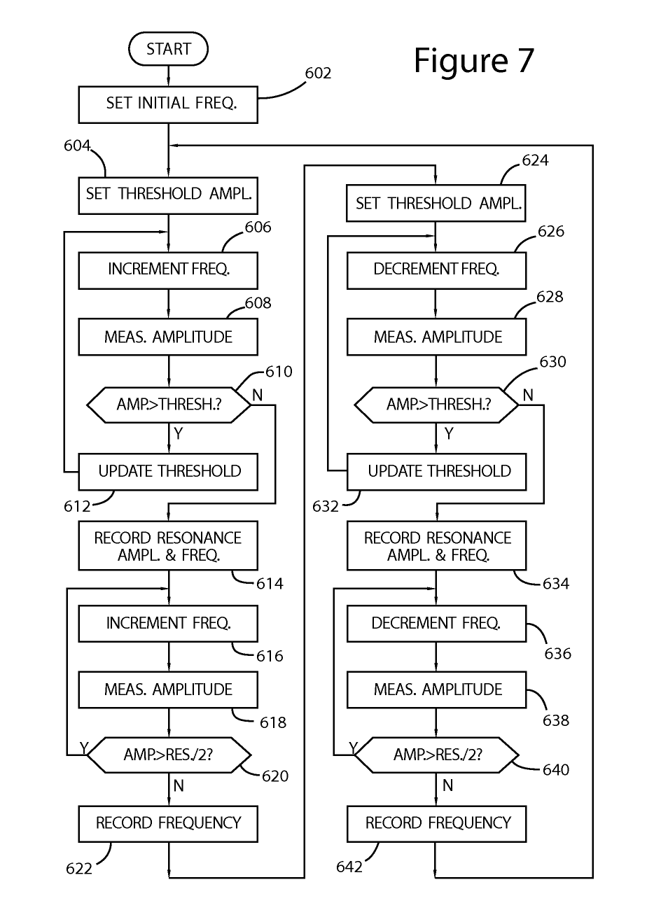

In a third method, the measurement module employs an iterative technique to search for the maximum amplitude as the frequency is discretely varied. Any of the well-known search algorithms for minima or maxima may be used. One illustrative example is now described, but it is recognized that the invention is not limited to the described details. In essence, the exemplary search method uses a back-and-forth search method in which the measurement module sweeps the vibration source frequency from one half-amplitude point across the peak to the other half-amplitude point and back again. One implementation of this method is shown in FIG. 7. In block 602, vibration is induced at an initial (minimum) frequency. In block 604, the vibration amplitude at the current vibration frequency is measured and set as a threshold. In block 606, the frequency is increased by a predetermined amount, and in block 608, the amplitude at the new frequency is measured. Block 610 compares the measured amplitude to the threshold, and if the amplitude is larger, then the threshold is set equal to the measured amplitude in block 612. Blocks 606-612 are repeated until the measured amplitude falls below the threshold. At this point, the threshold indicates the maximum measured amplitude, which occurred at the resonance peak. The amplitude and frequency are recorded in block 614. The frequency increases and amplitude measurements continue in blocks 616 and 618, and block 620 compares the amplitude measurements to half the recorded resonance frequency. Blocks 616-620 are repeated until the amplitude measurement falls below half the resonance peak amplitude, at which point, the half-amplitude frequency is recorded in block 622. Blocks 624-642 duplicate the operations of corresponding blocks 602-622, except that the frequency sweep across the resonance peak occurs in the opposite direction. For each peak crossing, the measurement module records the resonance amplitude and frequency, and then records the subsequent half-amplitude frequency. From this information the peak width and asymmetry can be determined, and the fluid density, viscosity, and multiple phase information can be calculated.

### Applications

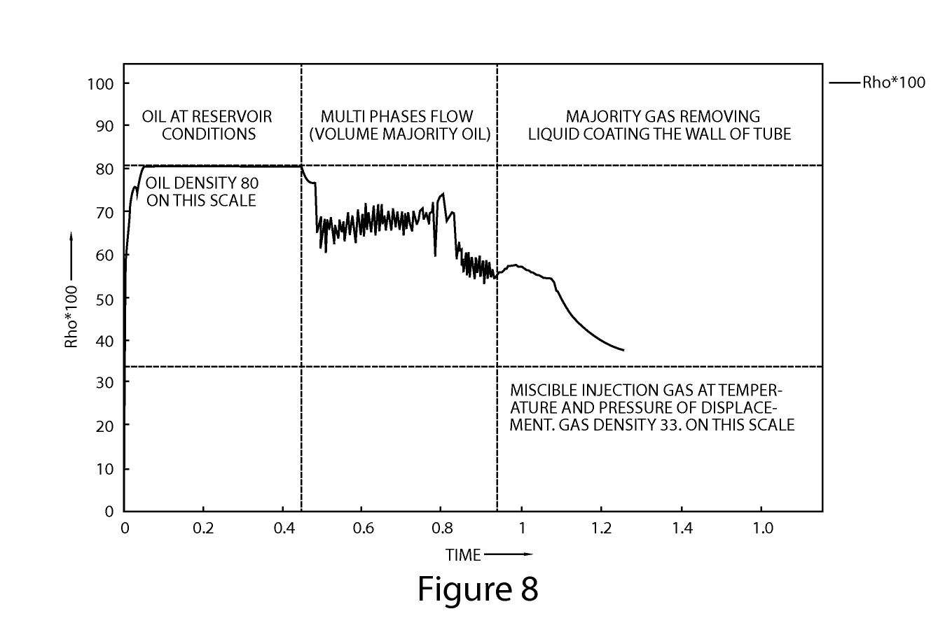

FIG. 8 shows an example of density measurements made according to the disclosed method as a function of time. Initially, the sample flow tube fills with oil, and the density measurement quickly converges to a specific gravity of 0.80. As a miscible gas is injected into the flow stream, the sample tube receives a multiple-phase flow stream, and the density measurement exhibits a significant measurement variation. As the flow stream becomes mostly gas, the oil forms a gradually thinning coating on the wall of the tube, and the density measurement converges smoothly to 0.33. It is noted, that in the multiple-phase flow region, the density measurement exhibits a variance that may be used to detect the presence of multiple phases.

Air or gas present in the flowing fluid affects the densitometer measurements. Gas that is well-mixed or entrained in the liquid may simply require slightly more drive power to keep the tube vibrating. Gas that breaks out, forming voids in the liquid, will reduce the amplitude of the vibrations due to damping of the vibrating tube. Small void fractions will cause variations in signals due to local variation in the system density, and power dissipation in the fluid. The result is a variable signal whose envelope corresponds to the densities of the individual phases. In energy-limited systems, larger void fractions can cause the tube to stop vibrating altogether when the energy absorbed by the fluid exceeds that available. Nonetheless, slug flow conditions can be detected by the flowmeter electronics in many cases, because they manifest themselves as periodic changes in measurement characteristics such as drive power, measured density, or amplitude. Because of the ability to detect bubbles, the disclosed densitometer can be used to determine the bubble-point pressure. As the pressure on the sample fluid is varied, bubbles will form at the bubble point pressure and will be detected by the disclosed device.

If a sample is flowing through the tube continuously during a downhole sampling event, the fluids will change from borehole mud, to mud filtrate and cake fragments, to majority filtrate, and then to reservoir fluids (gas, oil or water). When distinct multiple phases flow through the tube, the sensor output will oscillate within a range bounded by the individual phase densities. If the system is finely homogenized, the reported density will approach the bulk density of the fluid. To enhance the detection of bulk fluid densities, the disclosed measurement devices may be configured to use higher flow rates through the tube to achieve a more statistically significant sample density. Thus, the flow rate of the sample through the device can be regulated to enhance detection of multiple phases (by decreasing the flow rate) or to enhance bulk density determinations (by increasing the flow rate). If the flow conditions are manipulated to allow phase settling and agglomeration (intermittent flow or slipstream flow with low flow rates), then the vibrating tube system can be configured to accurately detect multiple phases at various pressures and temperatures. The fluid sample may be held stagnant in the sample chamber or may be flowed through the sample chamber.

Peak shapes in the frequency spectrum may provide signatures that allow the detection of gas bubbles, oil/water mixtures, and mud filtrate particles. These signatures may be identified using neural network “template matching” techniques, or parametric curve fitting may be preferred. Using these techniques, it may be possible to determine a water fraction from these peak shapes. The peak shapes may also yield other fluid properties such as compressibility and viscosity. The power required to sustain vibration may also serve as an indicator of certain fluid properties.

In addition, the resonance frequency (or frequency difference) may be combined with the measured amplitude of the vibration signal to calculate the sample fluid viscosity. The density and a second fluid property (e.g. the viscosity) may also be calculated from the resonance frequency and one or both of the half-amplitude frequencies. Finally, vibration frequency of the sample tube can be varied to determine the peak shape of the sample tube's frequency response, and the peak shape used to determine sample fluid properties.

The disclosed instrument can be configured to detect fluid types (e.g. fluids may be characterized by density), multiple phases, phase changes and additional fluid properties such as viscosity and compressibility. The tube can be configured to be highly sensitive to changes in sample density and phases. For example, the flow tubes may be formed into any of a variety of bent configurations that provide greater displacements and frequency sensitivities. Other excitation sources may be used. Rather than using a variable frequency vibration source, the tubes may be knocked or jarred to cause a vibration. The frequencies and envelope of the decaying vibration will yield similar fluid information and may provide additional information relative to the currently preferred variable frequency vibration source.

The disclosed devices can quickly and accurately provide measurements of downhole density and pressure gradients. The gradient information is expected to be valuable in determining reservoir conditions at locations away from the immediate vicinity of the borehole. In particular, the gradient information may provide identification of fluids contained in the reservoir and the location(s) of fluid contacts. Table 1 shows exemplary gradients that result from reservoir fluids in a formation.

TABLE 1

| | Density | Gradient |
|---|---|---|
| Fluid | Gm/cc | psi/ft |
| Low Pressure Gas Cap | 0.10 | 0.04 |
| Gas Condensate | 0.20 | 0.09 |
| Light Oil | 0.50 | 0.22 |
| Med. Oil | 0.70 | 0.30 |
| Heavy Oil | 0.90 | 0.39 |
| Pure Water | 1.00 | 0.43 |
| Formation Water | >=1.00 | >=0.43 |
| Mud Filtrate (from 8.7 ppg) | 1.04 | 0.45 |
| Completion Brine | 1.08 | 0.47 |
| Mud (12.5 ppg) | 1.50 | 0.65 |

Determination fluid contacts (Gas/Oil and Oil/Water) is of primary importance in reservoir engineering. A continuous vertical column may contain zones of gas, oil and water. Current methods require repeated sampling of reservoir pressures as a function of true vertical depth in order to calculate the pressure gradient (usually psi/ft) in each zone. A fluid contact is indicated by the intersection of gradients from two adjacent zones (as a function of depth). Traditionally, two or more samples within a zone are required to define the pressure gradient.

The pressure gradient (Δp/Δh) is related to the density of the fluid in a particular zone. This follows from the expression for the pressure exerted by a hydrostatic column of height h.

P=ρ*g*h (1)

where P denotes pressure, ρ denotes density, g denotes gravitational acceleration, and h denotes elevation.

In a particular zone, with overburden pressure which differs from that of a continuous fluid column, the density of the fluid may be determined by measuring the pressure at two or more depths in the zone, and calculating the pressure gradient:

$$ρ = \frac{Δ P / Δ h}{g} \qquad ( 2 )$$

However, the downhole densitometer directly determines the density of the fluid. This allows contact estimation with only one sample point per zone. If multiple samples are acquired within a zone, the data quality is improved. The gradient determination can then be cross-checked for errors which may occur. A high degree of confidence is achieved when both the densitometer and the classically determined gradient agree.

Once the gradient for each fluid zone has been determined, the gradient intersections of adjacent zones are determined. The contact depth is calculated as the gradient intersection at true vertical depth.

### Deterministically Ascertained Model for Determining Density

In an embodiment, another technique for computing fluid density relies on a deterministically ascertained model of the vibrating tube densitometer. In physics terms, the vibrating tube densitometer is a boundary value problem for a mass loaded tube with both ends fixed. The problem of a simple tube with fixed ends is described well by the classical Euler-Bernoulli theory. However, the physics of the actual densitometer device is more complicated. In one embodiment of a model of the vibrating-tube densitometer shown in FIG. 1, 2, or 3, the following effects/factors are taken into consideration:

1. Effect of any tensile/compressive load caused by the housing on vibration of the tube;

2. Effect of the two magnets and their mounting, their masses and their locations on the tube and their influence on the frequency;

3. Effect of pressure on tubing inside diameter (“ID”), outside diameter (“OD”) and area moment of inertia;

4. Poisson's ratio of the tube material and its temperature dependence;

5. Poisson's effect due to internal pressure and the resulting change in the tension;

6. Effect of tension in the tube on the housing, which in turn changes the tension in the tube and vice versa;

7. Effect of thermal stress due to the existence of temperature gradient between the tube and housing;

8. Precise value of the elastic modulus of the material from which the rigid housing 102, bulkheads 104, and the flow tube 108 are made (e.g., the alloy H-6Al-4V);

9. Temperature dependence of the elastic modulus;

10. Effect of temperature on the values of water and air density used in calibration;

11. Effect of fluid flow on the resonant frequency;

12. Effect of Coriolis force on the resonant frequency; and

13. Effect of fluid viscosity on the resonant frequency of the tube.

For someone skilled in the art of the dynamics of vibration system, it can be shown that the basic equation describing the motion of simple vibrating tube in the densitometer is the Euler-Bernoulli theory:

$$EI \frac{{\partial }^{4} ψ ( x , t )}{\partial {x}^{4}} + ρ A \frac{{\partial }^{2} ψ ( x , t )}{\partial {t}^{2}} = 0 \qquad ( 3 )$$

where

x=variable representing the distance from one end of the tube

t=time variable

Ψ=variable representing the transverse displacement of the tube

E=Young's modulus of the tube material

I=area moment of inertia

ρ=density of the tube

A=cross sectional area of the tube

However, in reality, the actual densitometer is more complicated than a simple vibrating tube. The above equation must be modified in order to fully describe the motion of the densitometer. In one embodiment, a series of additional loading terms are added to the basic equation. Starting with Newton's law, in one embodiment, the total force acting on a small tube and fluid element of the tube is:

$$( {m}_{r} + {m}_{L} ) \frac{{\partial }^{2} ψ}{\partial {t}^{2}} = - EI \frac{{\partial }^{4} ψ}{\partial {x}^{4}} + {f}_{P} + {f}_{T} + {f}_{C} + {f}_{V} + {f}_{M} \qquad ( 4 )$$

where

m_{L}=linear density of the fluid inside the tube

m_{T}=linear density of the tube material

fₚ=force on tube due to pressure

f_{T}=additional tensile force on tube

f_{c}=Coriolis force

f_{V}=force on tube due to fluid flow

f_{M}=additional mass loading due to the presence of the magnets

From detailed force analysis, it can be shown that the forces are given by:

$${f}_{P} = - PA \frac{{\partial }^{2} ψ}{\partial {x}^{2}} \\ {f}_{T} = T \frac{{\partial }^{2} ψ}{\partial {x}^{2}} \\ {f}_{C} = - 2 {m}_{L} V \frac{{\partial }^{2} ψ}{\partial t \partial x} \\ {f}_{V} = - {m}_{L} {V}^{2} \frac{{\partial }^{2} ψ}{\partial t \partial x} \\ {f}_{M} = {M}_{1} \frac{{\partial }^{2} ψ}{\partial {t}^{2}} δ ( x - {x}_{1} ) + {M}_{2} \frac{{\partial }^{2} ψ}{\partial {t}^{2}} δ ( x - {x}_{2} ) \qquad ( 5 )$$

where

P=Fluid Pressure inside tube

T=tension in the tube

V=flow velocity of the fluid

M_{1,2}=masses of the two magnets on the tube

X_{1,2}=locations of the two magnets on the tube

δ(x−x_{1,2})=Dirac delta-functions at x₁ and x₂

In the above differential equation, T is the total tension on the tube. Because of the Poisson effect and since the vibrating tube is fixed at two ends by its housing, the presence of pressure inside the tube produces additional tension on the tube which can be found to be, assuming a perfectly rigid housing:

$${T}_{P} = \frac{π}{2} {vb}^{2} P \qquad ( 6 )$$

where v is the Poisson's ratio of the tube material and b is the inner radius of the tube. However, because the housing does not have infinite rigidity, the tension from the tube will result in tension on the housing, which in turn will lead to slightly reduced tension in the tube. Let g=(a²−b²)/(A²−B²), a purely geometric factor of the sensor with a, b the outer and inner radius of the tube, A, B the outer and inner radius of the housing, respectively. Analysis of this process leads to a modification of the expression for tension due to pressure:

$${T}_{P} = \frac{π}{2} {b}^{2} vP \cdot [ {lim}_{n \to ∞} {\sum }_{n = 0}^{∞} {( - g )}^{n} ] = \frac{π {b}^{2} vP}{2 ( 1 + g )} \qquad ( 7 )$$

Furthermore, the existence of any temperature difference between the housing and the tube leads to a thermal stress in the tube which can be found to be:

$${F}_{t} = \frac{πα E}{4} ( {a}^{2} - {b}^{2} ) ( {T}_{h} - {T}_{t} ) \qquad ( 8 )$$

where α is the thermal expansion coefficient of the tube material, Tₕ and Tₜ are the temperature of the housing and the tube, and a, b are the outer and inner diameter of the tube, respectively.

The 4th order partial differential equation (4) with fixed ends boundary conditions can be solved analytically using well-established techniques such as the method of Laplace transform. The solution yields a complex frequency equation consisting of various combination of transcendental functions of the form

$$2 {ɛ}_{1}^{7} {ɛ}_{2}^{3} cos ( {ɛ}_{1} ) + 4 {ɛ}_{1}^{5} {ɛ}_{2}^{5} cos ( {ɛ}_{1} ) + 2 {ɛ}_{1}^{3} {ɛ}_{2}^{7} cos ( {ɛ}_{1} ) - 2 {ɛ}_{1}^{7} {ɛ}_{2}^{3} cosh ( {ɛ}_{2} ) - 4 {ɛ}_{1}^{5} {ɛ}_{2}^{5} cosh ( {ɛ}_{2} ) + … + {( β L )}^{8} {α}_{1} {α}_{2} {ɛ}_{1}^{3} {ɛ}_{2} cos ( {ɛ}_{1} ) sinh ( {ɛ}_{2} ) sinh ( {ɛ}_{2} {ξ}_{1} ) sinh [ {ɛ}_{2} ( {ξ}_{2} - {ξ}_{1} ) ] sinh [ {ɛ}_{2} ( 1 - {ξ}_{2} ) ] + {( β L )}^{8} {α}_{1} {α}_{2} {ɛ}_{1}^{3} {ɛ}_{2} cosh ( {ɛ}_{2} ) sinh ( {ɛ}_{2} ) sinh ( {ɛ}_{2} {ξ}_{1} ) sinh [ {ɛ}_{2} ( {ξ}_{2} - {ξ}_{1} ) ] sinh [ {ɛ}_{2} ( 1 - {ξ}_{2} ) ] = 0 \\ where \\ {ξ}_{1 , 2} = \frac{{x}_{1 , 2}}{L} , \\ {α}_{1 , 2} = \frac{{M}_{1 , 2}}{( {m}_{t} + {m}_{f} ) \cdot L} , \\ {ξ}_{1} = L \sqrt{\frac{B}{2} + \frac{1}{2} \sqrt{{B}^{2} + 4 {β}^{2}}} , \\ {ξ}_{2} = L \sqrt{- \frac{B}{2} + \frac{1}{2} \sqrt{{B}^{2} + 4 {β}^{2}}} , \\ B = \frac{π}{4} ⌊ {b}^{2} ( P ) P ( 1 - \frac{2 v}{1 + η} ) + \frac{α E ( T )}{1 + η} [ {a}^{2} ( P ) - {b}^{2} ( P ) ] ( {T}_{h} - {T}_{t} ) ⌋ \qquad ( 9 )$$

L=length of the vibrating tube
   Note that for clarity, many terms in the frequency equation have been omitted. But one skilled in the art of partial differential equations can generate these terms.

Once temperature, pressure, and fluid density are known, Equation (9) can be solved to yield the wave number β₀ that is related to the resonance frequency f₀ of the vibrating tube as

$${f}_{0} = \frac{{β}_{0}^{2}}{2 π {L}^{2}} \sqrt{\frac{E ( {T}_{t} ) \cdot I ( {T}_{t} )}{{m}_{t} + {m}_{f}}} \qquad ( 10 )$$

where

f₀ is the resonance frequency of the tube having a density ρₜ with fluid having density ρ_{f} and both at pressure P and temperature tₜ and housing at temperature tₕ.

$${m}_{t} = {ρ}_{t} \cdot \frac{π}{4} [ {a}^{2} ( P ) - {b}^{2} ( P ) ]$$

the linear density of the tube,

$${m}_{f} = {ρ}_{f} \cdot \frac{π}{4} {b}^{2} ( P )$$

the linear density of fluid,

E(tₜ) is the temperature dependent Young's modulus,

I(tₜ) temperature dependent area moment of inertia of the tube.

a(P), b(P) are the outer and inner diameter of the vibrating tube at pressure P.

β₀ is not a constant. Rather it depends on all the physical parameters of the densitometer. Thus, changes in temperature, pressure, fluid density, mass of the magnets, Young's modulus values all lead to change in β₀.

Solving Equation (9) constitutes a forward problem: given ρ_{f}, P, th, and tt, solve for the resonance frequency of the vibrating tube.

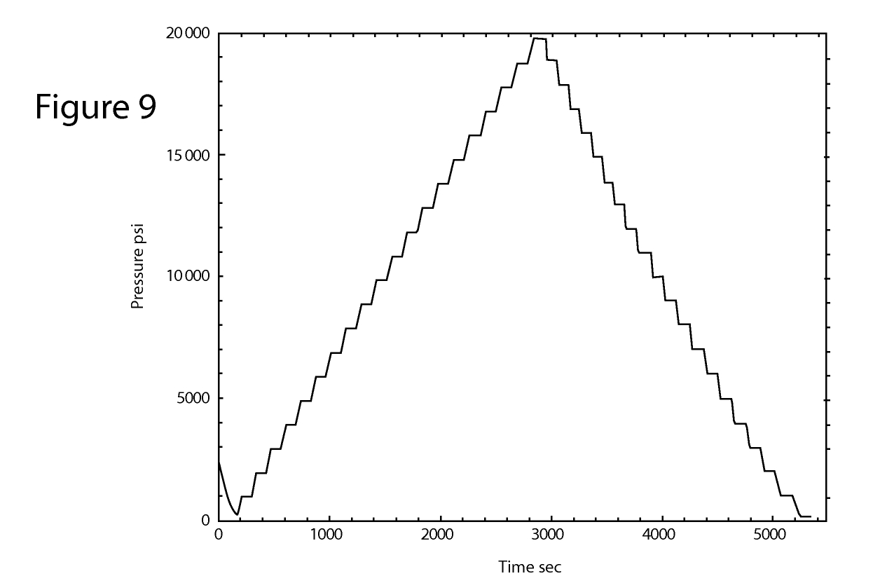

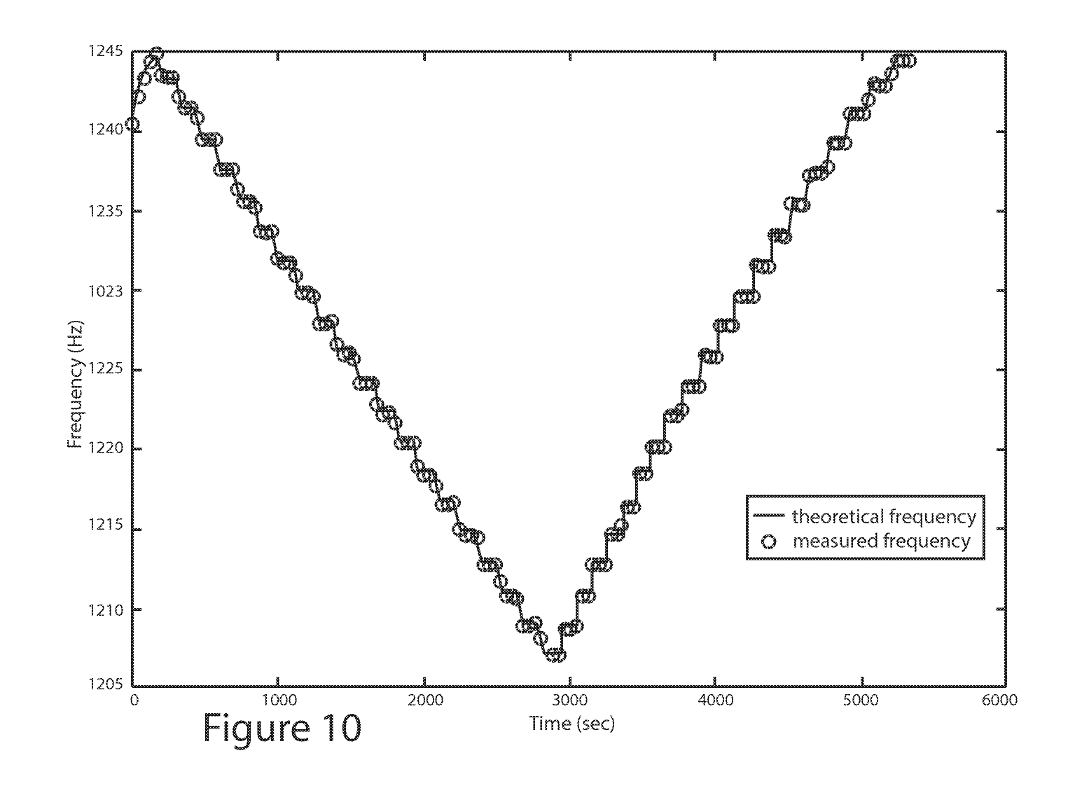

The accuracy of the above solution is demonstrated in FIGS. 9 and 10 for a prototype densitometer operating at room temperature with water in the tube under pressure up to 20,000 psi. FIG. 9 shows a pressure-time profile. FIG. 9 shows a theoretical result curve and an experimental data curve. The experimental data is so close to the theoretical data that they lay on top of each other and are indistinguishable in FIG. 9. FIG. 10 shows a line chart representing a forward model prediction of frequency versus time based on the pressure-time profile in FIG. 9 with open circles representing measured values.

In obtaining the result shown in FIG. 10, only a single adjustable parameter is necessary. Furthermore, this adjustable parameter can be easily fixed by comparing the theoretical frequency and measured frequency at a single pressure, temperature and fluid density point. In other words, a single point calibration is all that is necessary to match the complete pressure profile.

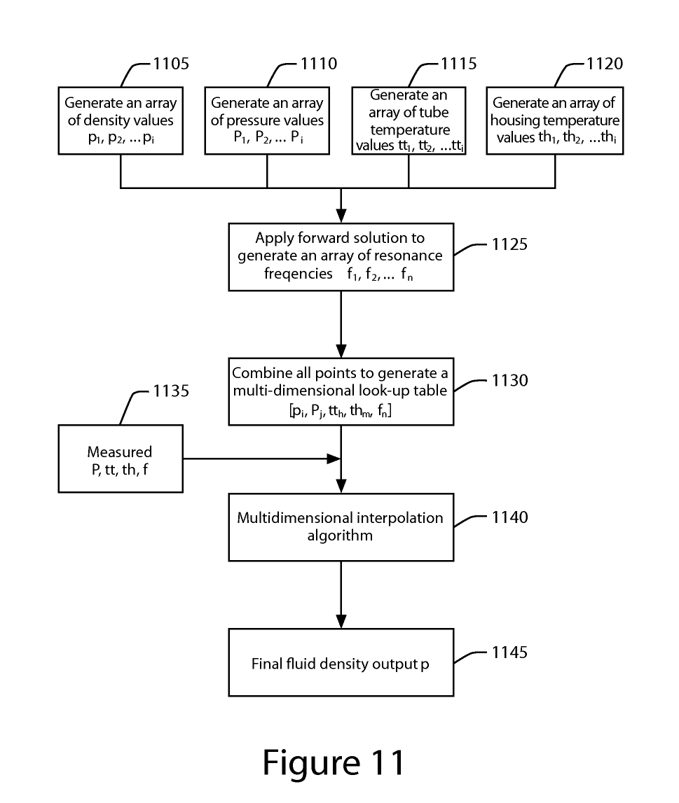

With solution of the forward problem, the inverse problem of solving for density ρ_{f} given the measured resonance frequency f₀, P, Tₜ and Tₕ, becomes possible. For example, as shown in FIG. 11, a technique for solving the inverse problem includes generating an array of density values ρ₁, ρ₂, . . . ρᵢ (block 1105), an array of pressure values P₁, P₂, . . . Pᵢ (block 1110), an array of tube temperature values tt₁, tt₂, . . . ttᵢ (block 1115), and an array of housing temperature values th₁, th₂, . . . thᵢ (block 1120). The forward solution is then applied to a set of n values of ρ, P, Tₜ and Tₕ, to generate a list of corresponding resonance frequencies f₁, f₂, . . . fₙ at these combinations of measured quantities (block 1125). A look-up table is then generated from the corresponding values of ρ, P, Tₜ, Tₕ, and f (block 1130). The look-up table can be stored either in the sensor's electronic memory or stored in a computer. During operation of the densitometer, each measured set of data points (ρ, P, tₜ, tₕ) is checked against the look-up table (block 1135). A computer algorithm (such as a multidimensional interpolation algorithm) (block 1140) is used to identify the density of the fluid (block 1145).

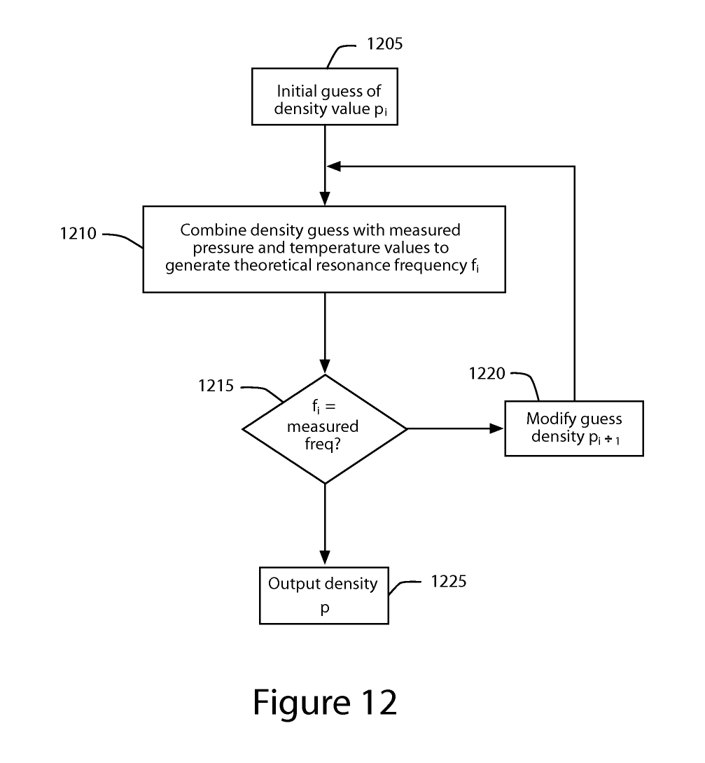

In another embodiment a trial-and-error method of finding the density of fluid, illustrated in FIG. 12, is used. In this technique, an initial guess of density value ρᵢ, is made (block 1205). That guessed density value is then combined with measured pressure and temperature values to generate a theoretical resonance frequency fᵢ (block 1210). The theoretical resonance frequency is then compared to the measured frequency (block 1215). If they are not substantially the same (i.e., within 0.1 percent), the density guess is modified to generate a new density guess ρᵢ₊₁ (block 1220) and blocks 1210 and 1215 are repeated. These blocks are repeated until the theoretical resonance frequency is substantially the same as the measured frequency. At that point, the density ρ is output (block 1225).

### Numerical Solution of Density Measurement

In another embodiment, the 4th order partial differential equation (4) with known boundary conditions is solved numerically, using well established numerical methods such as Runge-Kutta method, finite difference method, finite element method, shooting method, etc.

One example using the shooting method is explained below. The densitometer with both ends fixed presents a classic eigenvalue problem in mathematics. For simplicity of discussion, one can neglect the effect of all external forces listed above. After separation of variables, the eigenvalue problem can then be written as:

$$\frac{{d}^{4} ψ ( x )}{d {x}^{4}} - {β}^{4} ψ ( x ) = 0 , \\ ψ ( 0 ) = ψ ( 1 ) = 0 , \\ {ψ}^{′} ( 0 ) = {ψ}^{′} ( 1 ) = 0 \qquad ( 11 )$$

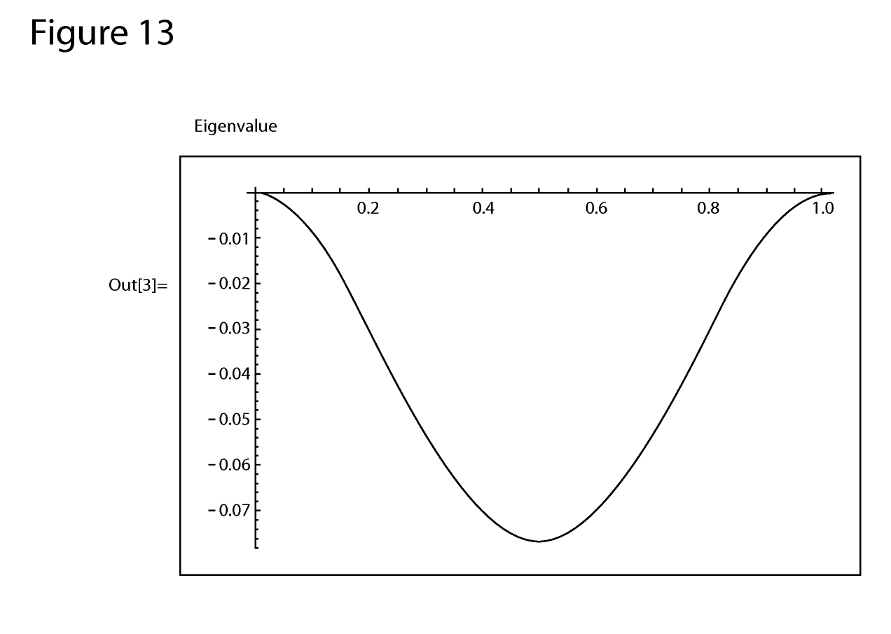

The two point boundary value problem can be cast into an initial value problem using the shooting method:

$$\frac{{d}^{4} ψ ( x )}{d {x}^{4}} - {β}^{4} ψ ( x ) = 0 , \\ ψ ( 0 ) = {ψ}^{′} ( 0 ) = 0 , \\ {ψ}^{″} ( 0 ) = α , \\ {{ψ}^{′}}^{″} ( 1 ) = const . \qquad ( 12 )$$

where the value of a and eigenvalue β are to be determined by matching the boundary condition at the other end of the tube: ψ(1)=0, ψ′(1)=0. This is illustrated in FIG. 13 where the Mathematica software is used to vary ψ″(0) and β until the conditions ψ(1)=0, ψ′(1)=0 are met. At this point, the shape of the curve identifies the first eigenmode. Its eigenvalue determines the fundamental frequency.

In one embodiment, this process is automated.

Once the eigenvalue is found, in one embodiment, the corresponding frequency is then calculated. At this stage, the process described above becomes applicable.

### Determination of Young's Modulus for Density Measurement

Equation (10) above uses the temperature dependent Young's modulus of the tube (E(tₜ)). Techniques for determining E(tₜ) are now described.

Determination of Young's Modulus at Room Temperature for Density Measurement

Speed of Sound Using Accelerometers to Measure Time of Flight

For an isotropic material, its speed of sound is determined by Young's modulus E and density ρ as

$$c = \sqrt{\frac{E}{ρ}} \qquad ( 13 )$$

Using compressional wave, previously this relationship was used to roughly estimate E at room temperature using accelerometers to measure time of flight two points. However, this method has flaws. One flaw is that the time resolution is insufficient given the short (˜6 inches) separation between the two accelerometers. But more importantly, both the compressional AND shear wave velocity needed to be considered in order to arrive at a better estimate of the E value:

$$E = {V}_{s}^{2} ρ \frac{3 {V}_{c}^{2} - 4 {V}_{s}^{2}}{{V}_{c}^{2} - {V}_{s}^{2}} \qquad ( 14 )$$

With the short separation and small shear wave signal, using accelerometers to detect both compressional and shear wave is a challenge.

Ultrasonic Pulse-Echo Method

An alternative way to determine speed of sound is using ultrasonic transceivers. With the standard pulse echo method, a high frequency (5 MHz) ultrasonic pulse is transmitted into the tube and the echo detected. With known length of the tube and measured time of flight, formula (2) may be used. Compared to the method of using accelerometer, the ultrasonic method has better time resolution and thus gives more accurate E values. Unfortunately, shear wave again posed a serious challenge. Furthermore, the thin wall thickness is comparable to the wave length. This will lead to complex modes of wave propagation in the tube thus render equation (10) inaccurate.

Beam Bending for Bulk Young's Modulus Determination

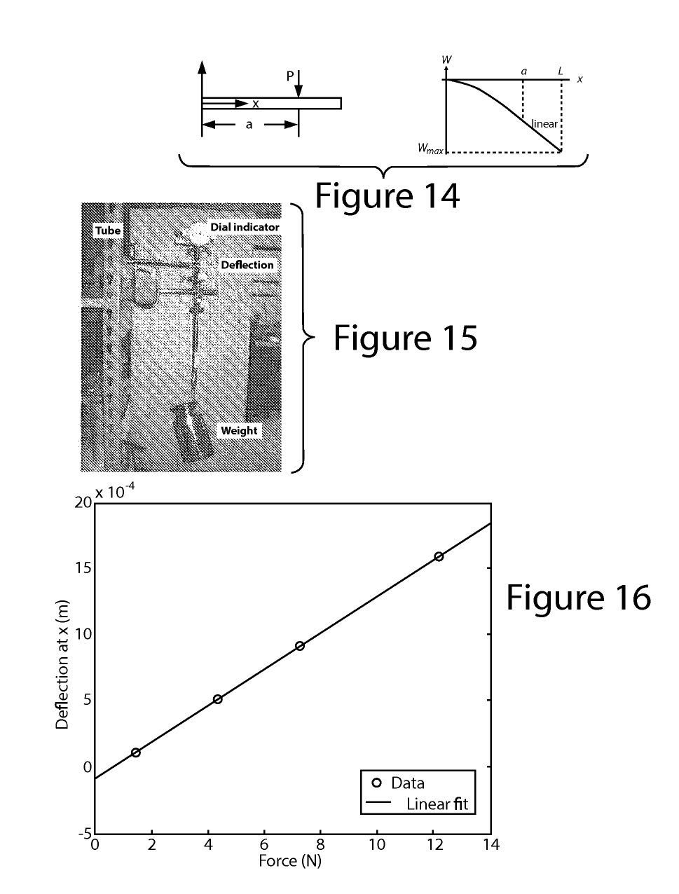

From Euler's beam theory, the deflection of a cantilever 1405 hanging under its own weight (see FIG. 14), is described by:

$$w ( x ) = \{ \begin{matrix}- \frac{{Px}^{2}}{6 EI} ( 3 a - x ) & 0 \leq x \leq a \\ - \frac{{Pa}^{2}}{6 EI} ( 3 x - a ) & a \leq x \leq L\end{matrix} \qquad ( 15 )$$

where P is the weight at position a, E is Young's modulus, I is the area moment of inertia of the tube which can be calculated knowing the outside diameter and inside diameter of the tube. The inventor set up a simple experiment, shown in FIG. 15, using known weights and a known tube length of the tube. A dial indicator with resolution of 0.01 mm was used to measure the defection of the tube under varying weights. The measured deflection as a function of changing weights (in Newtons) is shown in FIG. 16. The measured data is shown as open circles and is very close to linear. The reciprocal of the slope of a line fit to the measured data, as shown on FIG. 16, gives Young's modulus at room temperature.

Using the ultrasonic method and the beam bending method, the Young's modulus value of several tubes at room temperature was determined. The results are listed in Table 2 below.

TABLE 2
Measured Young's modulus values at room temperature.

| Method | 7.5″ tube | 10″ tube | 13″ tube |
|---|---|---|---|
| Ultrasonic pulse-echo | 76.2 GPa | 79.3 GPa | 73.4 GPa |
| Beam bending | 73 GPa | 80.7 GPa | 73.5 GPa |

Note that the measured Young's modulus values are below the 90-120 GPa that is generally quoted in the literature.

### Determination of Young's Modulus at Elevated Temperature for Density Measurement

Theoretical Derivation of the Method

The methods listed in the previous section work reasonably well at room temperature. But attempts to extend them to higher temperatures are challenging. Not only do the sensors have limited temperature range, but setting up the measurement inside an oven is also problematic.

The vibrating densitometer itself can be used to determine Young's modulus at elevated temperatures, provided the response of the densitometer to fluid of known density at elevated temperatures can be measured accurately. This approach is described in detail in the following:

The measured resonance frequency of the vibrating tube is expressed as

$${f}_{0} = \frac{{β}_{0}^{2} ( E ( {T}_{t} ) , {T}_{h} , {T}_{t} , P , {m}_{f} )}{2 π {L}^{2}} \sqrt{\frac{E ( {T}_{i} ) \cdot I}{{m}_{t} + {m}_{f}}} \qquad ( 16 )$$

where

β₀=Root of the complicated frequency equation (i.e., equation (9)),

Tₕ=Temperature of densitometer housing,

Tₜ=Temperature of vibrating tube,

P=Fluid pressure,

mₜ=Linear density of the tube,

m_{f}=Linear density of the fluid,

I=Area moment of inertia of the tube,

L=Length of tube,

E(Tₜ)=Young's modulus as function of tube temperature.

It can be shown that the root k depends only weakly on E(Tₜ) thus for all practical purposes can be treated as being independent of temperature. If one assumes a temperature independent Young's modulus value of E₀, then equation (16) can be used to calculate a “theoretical” frequency f₀(Tₜ) as:

$${f}_{0} = {( T )}_{t} \frac{{β}_{0}^{2} ( {E}_{0} , {T}_{h} , {T}_{t} , P , {m}_{f} )}{2 π {L}^{2}} \sqrt{\frac{{E}_{0} \cdot I}{{m}_{t} + {m}_{f}}} . \qquad ( 17 )$$

Without loss of generality, one can express the temperature dependent Young's modulus in Equation (16) in the form of a Taylor series as:

E(tₜ)=E₀(1+aTₜ+bTₜ²+cTₜ³+ . . . ), (18)

Substituting Equation (18) into Equation (16), taking the ratio of the squares of Equations (16) and (17), one arrives at the following relation:

$$E ( {T}_{t} ) = {E}_{0} \frac{{f}^{2}}{{f}_{0}^{2}} . \qquad ( 19 )$$

Note that in deriving equation (19), the assumption that β is only a slow-varying function of E(T) is used. That is, it is assumed that β₀(E₀, Tₕ, Tₜ, P, m_{f})≈β₀(E(Tₜ), Tₕ, Tₜ, P, m_{f}). Based on this relationship, one can obtain the temperature dependent Young's modulus by taking the ratio of the square of measured frequency to the square of the theoretically calculated frequency with an assumed constant Young's modulus.

Experimental Proof of the Method

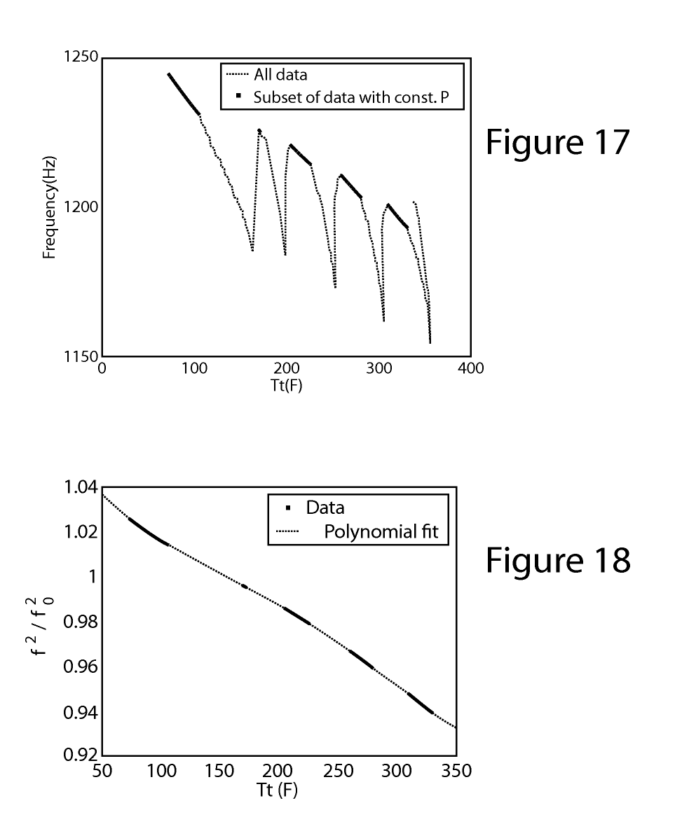

This assertion was checked against experimental data obtained for an existing sensor. In FIG. 17, the data is plotted against measured tube temperature. The solid portions of the plot indicate the subset of the data with constant fluid pressure values around 400 psi.

This subset of data is chosen to concentrate on the temperature behavior of the sensor alone without interference from the pressure behavior.

Using a constant Young's modulus value of E₀=93.9 GPa, a theoretical frequency response of the sensor f₀(E₀, Tₕ, Tₜ, P, m_{f}) was calculated using the experimentally measured housing temperature and tube temperature, as well as measured pressure, and known density of water at such temperature and pressure. The ratio of the square of the theoretical f₀ and measured f for the subset of data was plotted against measured tube temperature as shown in FIG. 18.

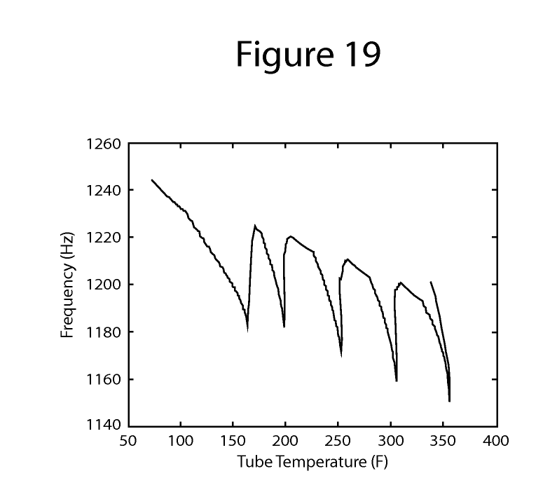

From FIG. 18, the 4th order polynomial fit to the data yields the desired temperature dependence of Young's modulus of the tube at elevated the temperatures. This relation is then substituted back into the theoretical frequency equation to produce the final theoretical prediction of resonance frequency. This final result is shown in FIG. 19.

With the exception at around 350 F, the residual using the new method lies within ±1 Hz. Furthermore, this technique is self-calibrated in that there is no calibration constant in the final theory. It should also be noted that none of the temperature sensors have been calibrated, which may lead to some additional experimental errors.

Technique for Solving the Frequency Equation (Equation 9)

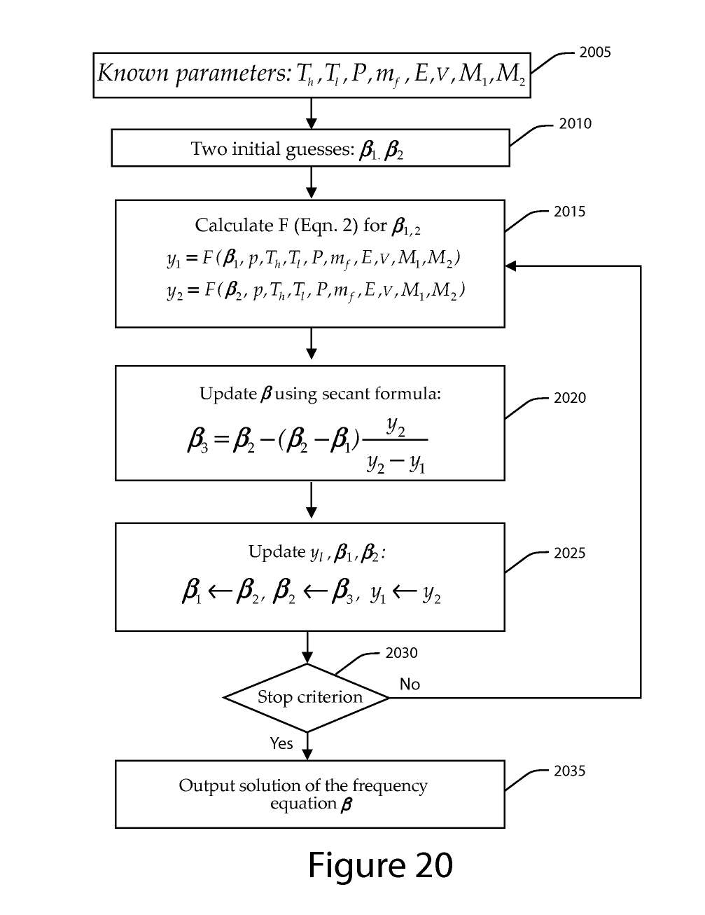

An embodiment of a technique for solving the frequency equation (equation (9)), illustrated in FIG. 20, begins with known parameters Tₕ, Tₜ, P, m_{f}, E, v, M₁, and M₂ (block 2005). The technique makes two initial guesses at β₀: β₁ and β₂ (block 2010). The technique then calculates F for β₁ and β₂ using equation (9) (block 2015). β₃, an updated β, is then calculated from β₁ and β₂ using the secant formula (block 2020). The values of y₁, β₁ and β₂ are then updated (block 2025). If a stop criterion has been reached (e.g., β₁−β₂<a threshold) (block 2030), the “Yes” branch from block 2030 is followed and the solution is output (block 2035). Otherwise, the technique returns to block 2015 (“No” branch from block 2030).

Technique to Obtain the Temperature Dependent Young's Modulus Based on Calibration Measurement

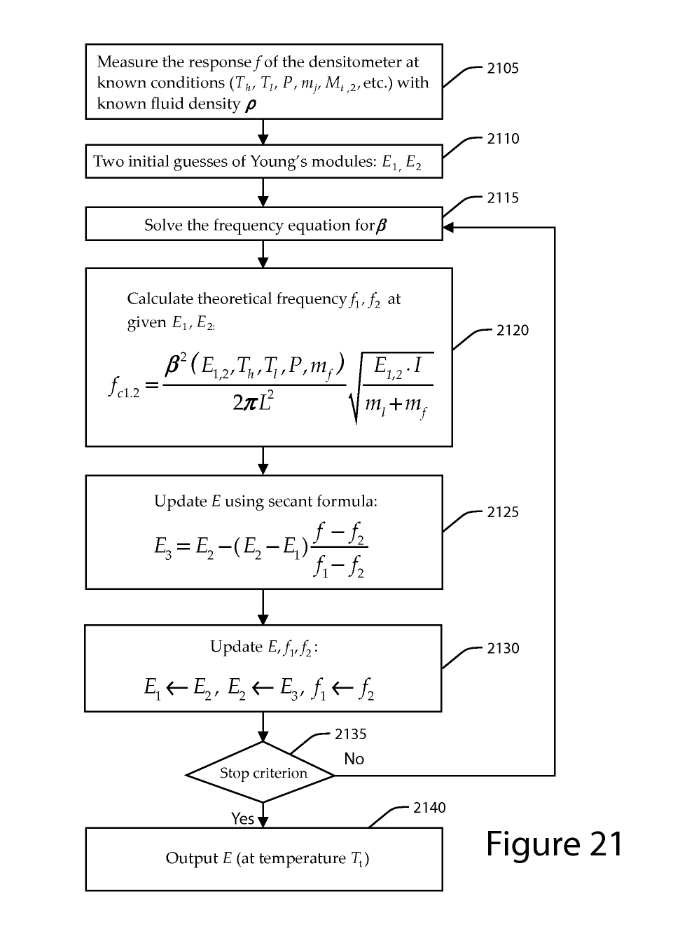

An embodiment of a technique to obtain the temperature dependent Young's Modulus based on calibration measurements, illustrated in FIG. 21, begins by measuring the response of the densitometer at known conditions (Tₕ, Tₜ, P, m_{f}, E, v, M₁, and M₂, etc.) with known fluid density ρ (block 2105). The technique then makes two initial guesses of Young's modulus: E₁ and E₂ (block 2110). The technique then solves the frequency equation (equation (9)) for β (block 2115). The technique then calculates the theoretical frequencies f₁ and f₂ at E₁ and E₂ using the equation shown in the figure (block 2120). The technique then updates E using the secant formula (block 2125) and updates E, f₁ and f₂ (block 2130). If a stop criterion has been reached (e.g., E₁−E₂<a threshold), the “Yes” branch from block 2135 is followed and a solution is output (block 2140). Otherwise, the technique returns to block 2115 (“No” branch from block 2135). The solution E returned at block 2140 is at temperature Tₜ.

Alternative Technique to Obtain the Temperature Dependent Young's Modulus Based on Calibration Measurement

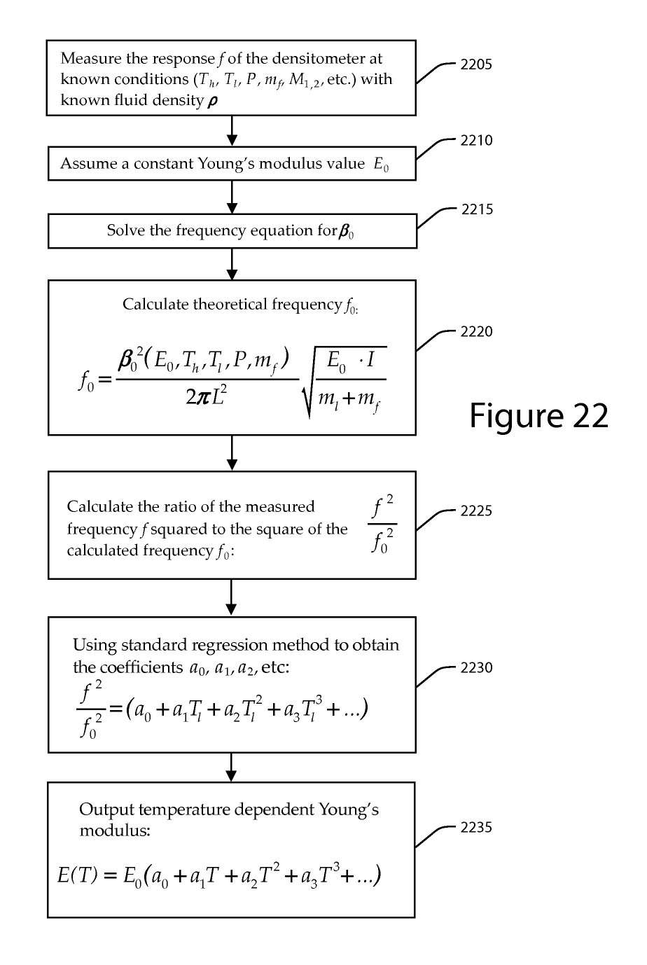

An alternative embodiment of a technique to obtain the temperature dependent Young's Modulus based on a calibration measurement, illustrated in FIG. 22, begins by measuring the response of the densitometer at known conditions (Tₕ, Tᵢ, P, m_{f}, M₁, and M₂, etc.) with a known fluid density p (block 2205). The technique next assumes a constant Young's modulus value E₀ (block 2210). The technique next solves the frequency equation (equation (9)) for β₀ (block 2215). The technique next calculates the theoretical frequency fₒ using the equation shown in the figure (block 2220). The technique next calculates the ratio of the square of the measured frequency f² to the square of the calculated frequency fₒ² (block 2225). The technique next uses a standard regression method to obtain the coefficients α₀, a₁, a₂, etc. to the equation shown in the figure (block 2230). The technique then outputs the temperature dependent Young's modulus calculated using the equation shown in the figure (block 2235).

Technique to Obtain the Temperature Dependent Young's Modulus Based on Calibration Measurement Using Simultaneous Solutions at Known Temperatures and Multiple Pressures

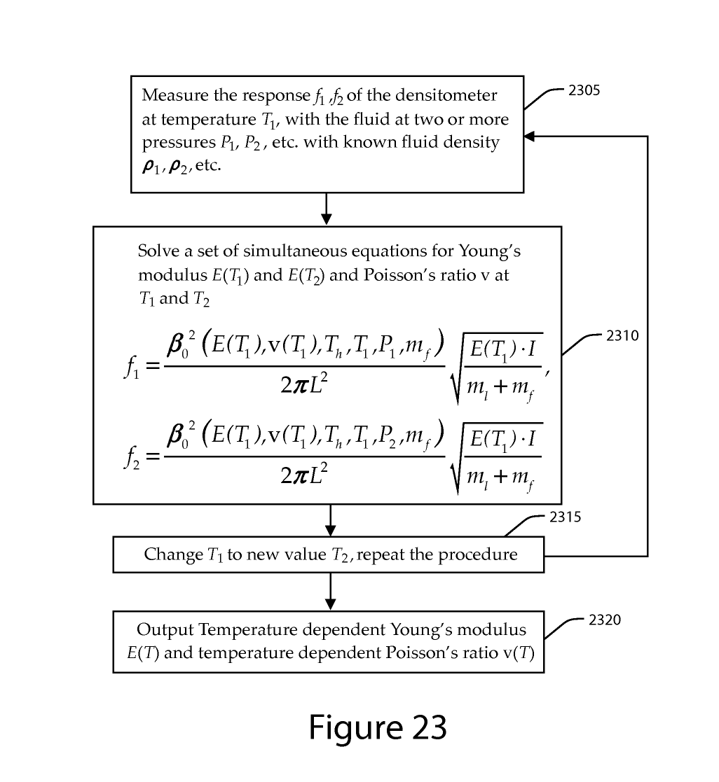

A technique to obtain the temperature dependent Young's Modulus based on calibration measurement using simultaneous solutions at known temperatures and multiple pressures, illustrated in FIG. 23, begins by measuring the response f₁, f₂ of the densitometer at temperature T₁, with the fluid at two or more pressures P₁, P₂, etc. with known fluid density ρ₁ ρ₂, etc. (block 2305). The technique next solves a set of simultaneous equations for Young's modulus E(T₁) and E(T₂) and Poisson's ratio v at T₁ using the equations shown in the figure (block 2310). The technique next changes T₁ to new value T₂ and returns to block 2305. When all of the temperatures have been investigated, the technique outputs the temperature dependent Young's modulus E(T) and temperature dependent Poisson's ratio v(T) (block 2320).

### Means for Determining Viscosity

Densitometers, such as the one described above, can be modified to also detect viscosity in downhole measurements. Means of determining viscosity can include one or more circuits incorporated into the described densitometer. The measurement module for viscosity can detect resonant frequency and determine a “Q” value, thereby determining both fluid density and viscosity.

Measurement Module for Determining Viscosity

The measurement module converts measurement of vibration into viscosity, based on the resonant frequency and/or the Q value of the vibrations.

In one embodiment, resonant frequency and Q can be determined in the time domain. In the time domain, the conduit is excited using an electric current pulse into the driver coil, or by imparting an impact force onto the conduit, such as by non-limiting example, using an electro mechanic hammer to strike the conduit. The temporal response of the device is recorded. Using a standard technique such as Fast Fourier Transform, the time domain response can be transformed into the frequency response from which both the resonance frequency and Q can be determined.

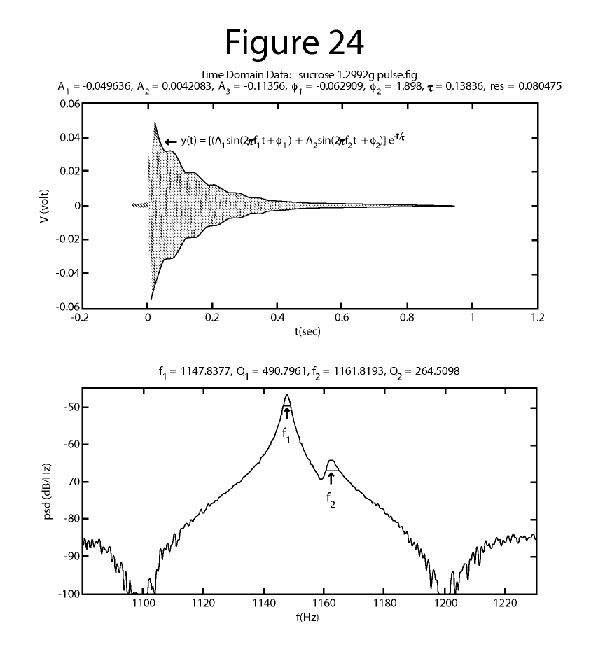

FIG. 24 shows an example of the time-domain response of the vibrating tube density sensor after being excited with an electric current pulse. The sample fluid is 1.2992 g/cc sucrose solution. The top graph shows raw data and the fitted envelope. The bottom graph shows the calculated power spectral density showing the two peaks and the half-max points. The resonance frequency for the two modes is extracted from the power spectral density (psd). In this example, the envelope of the time domain signal is obtained using Hilbert transform. Using nonlinear least square curve fitting technique, the envelope can be used to extract the coefficients A₁, A₂, and the time decay constant T from the expression for the signal:

y(t)=[A₁ sin(2πf₁t+φ₁)+A₂ sin(2πf₂t+φ₂)]^{(-t/τ)} (20)

If only a single resonance is present, the A₂=0, and the above equation simplifies to:

y(t)=[A₁ sin(2πf₁t+φ₁)]^{(-t/τ)} (21)

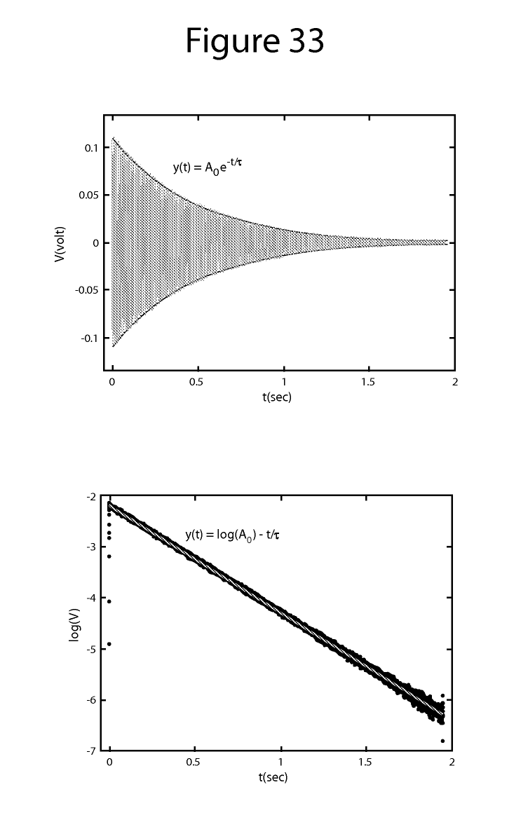

An alternative method of obtaining the time decaying constant τ from the time domain signal involves finding the envelop of the signal Y(t) via Hilbert transform of y(t). When log [Y(t)] is plotted against time, the slope gives the inverse of τ. This is illustrated in FIG. 33. In FIG. 33 a time domain decaying vibratory signal is shown on the top with its envelope obtained using Hilbert transform. On the bottom is a logarithmic plot of the envelope, wherein the slope is −1/τ.

Alternatively, both the resonance frequency and the Q value can be determined from frequency domain measurements. In the frequency domain, the frequency at which the sensor has maximum response can be identified by sweeping excitation frequency and monitoring the amplitude of the response signal such as voltage from a voice coil. The zero-crossing of the phase signal can also be identified by monitoring the phase change in the response.

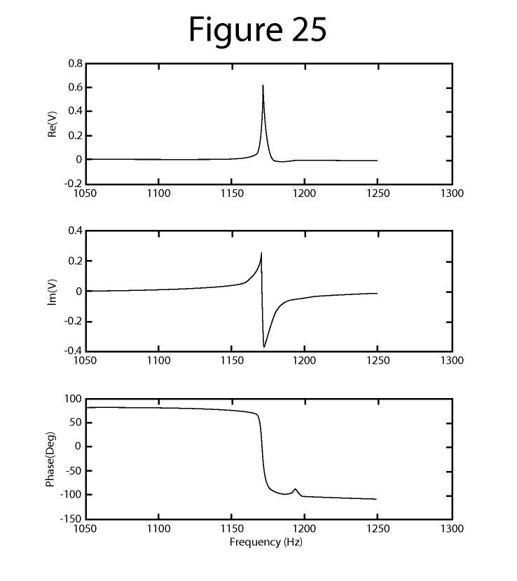

FIG. 25 shows an example of measuring the frequency response of the sensor, by sweeping the frequency of the driving signal, using a phase-sensitive detector (such as a lock-in amplifier or network analyzer). The top graph shows the real part of the voltage response from the voice coil. The middle graph shows the imaginary part of the response signal. The bottom graph shows the phase of the voice coil complex voltage. From the measured complex voltage signal, both resonance frequency and Q value can be directly obtained.

The Q value is related to the frequency at resonance (f₀) and Full Width Half Max (FWHM), which is shown in FIG. 5 as the Half-Amplitude Peak Width. Below is an equation of this relationship.

$$Q = \frac{Resonance Frequency}{Full Width Half Max} = \frac{{f}_{0}}{Δ f} \qquad ( 22 )$$

There are two methods to determine the Q value, which can be referred to as the Time Domain method and the Frequency Domain method, both of which are discussed herein and can be suitable for use in the present invention.

Time Domain Method:

An impulse can be used to excite the tube containing fluid into time decaying oscillation. The decaying oscillatory signal is recorded as function of time. This data is then transformed into frequency domain using Fourier transform to yield the so called power spectral density (psd) of the signal. Q is then determined from the psd plot using the equation above.

Frequency Domain Method:

a variable frequency signal is used to excite the tube containing fluid into oscillation. The frequency is varied such that it covers the frequency range from below the resonance to above the resonance. i.e., fₛₜₐᵣₜ<f<fₛₜₒₚ. The response of the vibrating tube density sensor is recorded as a function of the driving frequency, which gives the psd plot directly. Q is then determined in the same manner.

Scaling Q by the Fluid Density to Obtain Fluid Viscosity

In one embodiment, the Q value can be scaled by fluid density to obtain fluid viscosity.

When the fluid conduit filled with viscous fluid is excited into resonance, energy is dissipated due to viscous loss. This is in addition to other loss mechanisms in the resonator, such as mechanical loss, electronic circuit loss, acoustic radiation loss, etc. Hence, the measured Q value of the device reflects all these losses. It is commonly assumed that this Q value can be used directly to predict the viscosity of the fluid. However, experiments, such as the example below, have shown that there is lack of direct correlation between the Q value and fluid viscosity.

Instead of seeking direct correlation between the measured Q and fluid viscosity, one can scale Q by fluid density p and plot against fluid viscosity η. A correlation exists between Q/ρ and η. This correlation can be further developed based on the definition of the quality factor Q given by:

$$Q = 2 π \times \frac{Energy Stored}{Energy Dissipated percycle} = 2 π \frac{K . E .}{Δ K . E .} \qquad ( 23 )$$

The equation for the kinetic energy stored in the fluid of the vibrating tube is given by:

$$K . E . = \frac{1}{2} {\int }_{0}^{L} π {r}^{2} ρ ( x ) {( \frac{\partial ψ}{\partial t} )}^{2} d x = ρ \cdot [ \frac{π {r}^{2}}{2} {\int }_{0}^{L} {( \frac{\partial ψ}{\partial t} )}^{2} d x ] \qquad ( 24 )$$

Where r is the inner radius of the tube, Ψ(x,f) is the transverse motion of the tube at position x, and ρ(x) is the fluid density at position x. For homogenous fluids, ρ(x) is constant and can be taken out of the integration. The energy loss can be derived from:

ΔK.E.=−½\sqrt{½ωηρ} [symbol] |v₀|²ds (25)

where ω is the angular frequency of the vibration, v₀ is the velocity of the fluid at the tube surface. Combining these results, one finds that:

$$\frac{Q}{ρ} ∝ \frac{1}{\sqrt{ρη}} \qquad ( 26 )$$

That is, Q scaled by density is proportional to the inverse square root of the density-viscosity product.

In an alternative embodiment, instead of using Q divided by density to determine viscosity, one may use the decaying time constant τ/ρ.

The linear relationship between Q scaled by density ρ and the inverse of the square root of density-viscosity product can be expressed as:

$$\frac{Q}{ρ} = A + \frac{B}{\sqrt{ρη}} \qquad ( 27 )$$

Where A and B are the intercept and slope of the linear fit of Q/ρ plotted against 1/\sqrt{ρη}. From this expression, viscosity is obtained by:

$$η = \frac{{B}^{2}}{{( Q - A ρ )}^{2}} \qquad ( 28 )$$

The following is an example of measuring viscosity using a densitometer-viscometer to find Q value.

Fluids with different known viscosity values were prepared and tested for density and viscosity. Table 3 lists the properties of the prepared fluids.

TABLE 3
Fluids used in example.

| Fluid | density | visc (cP) |
|---|---|---|
| acetone | 0.7925 | 0.32 |
| water | 0.9988 | 1.0389 |
| sucrose | 1.0648 | 1.6209 |
| sucrose | 1.2259 | 12.232 |
| sucrose | 1.2427 | 19.034 |
| sucrose | 1.2848 | 48.962 |
| sucrose | 1.2992 | 69.795 |
| sucrose | 1.3034 | 84.853 |
| sucrose | 1.3189 | 144.87 |
| sucrose | 1.3217 | 152.23 |
| sucrose | 1.3220 | 169.38 |
| sucrose | 1.3326 | 231.11 |
| sucrose | 1.3339 | 251.04 |
| syrup | 1.3268 | 823.19 |

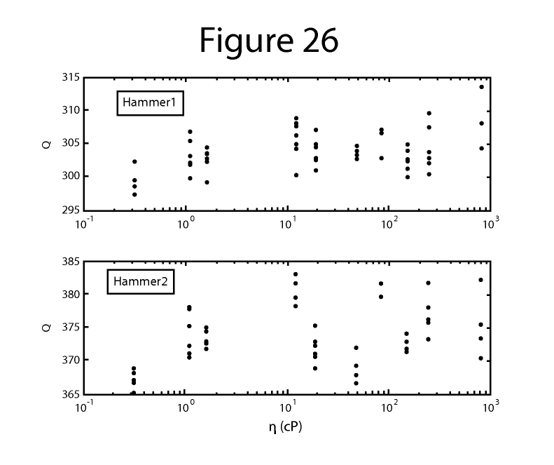

FIG. 26 shows measured Q values versus viscosity for these fluids using different excitations. FIG. 26 demonstrates the lacks of direct correlation between viscosity and Q values.

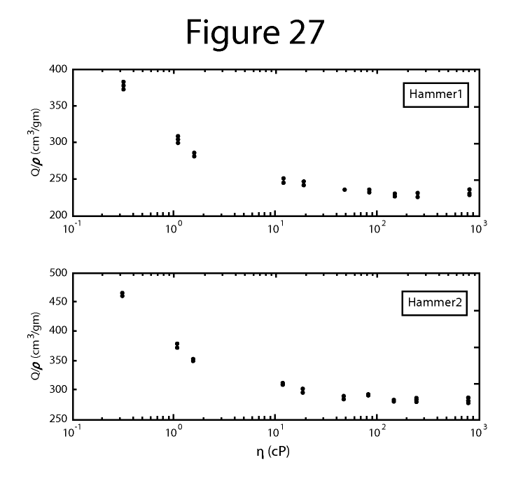

FIG. 27 shows Q values divided by density versus viscosity for the example fluids. FIG. 27 demonstrates that a correlation exists between Q/ρ and η.

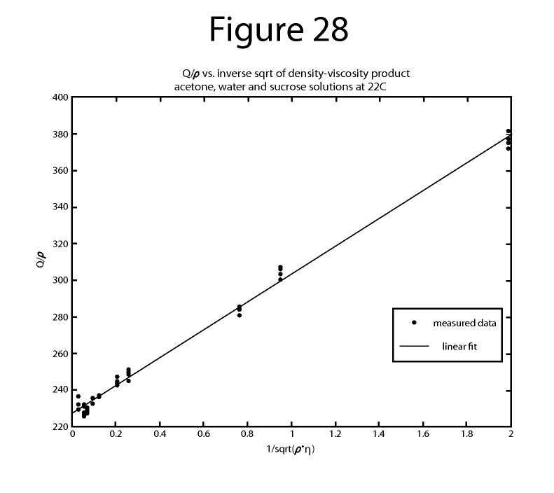

FIG. 28 shows Q/ρ versus the inverse square root of density-viscosity product for the example fluids. FIG. 28 demonstrates that Q scaled by density is proportional to the inverse square root of the density-viscosity product.

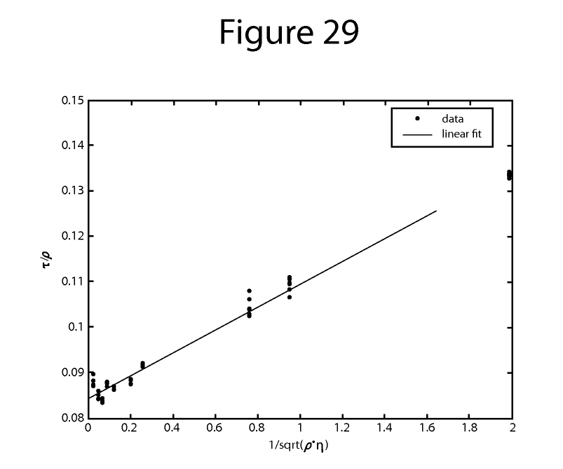

FIG. 29 shows decay time constant versus the inverse square root of the density-viscosity product for the example fluids. FIG. 29 demonstrates that τ/ρ is proportional to 1/\sqrt{ρη}.

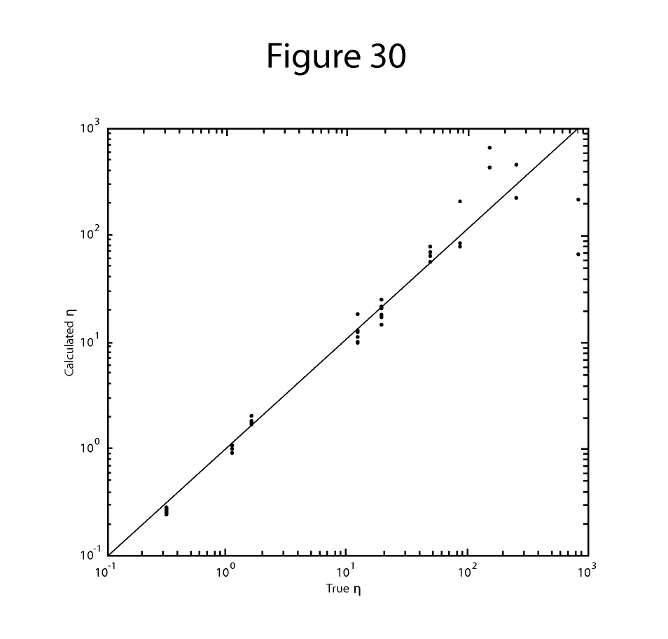

FIG. 30 shows viscosity determined according to an embodiment of the invention (that is, using equation 28) versus actual viscosity, as measured by an Anton Paar Rheometer. FIG. 30 demonstrates that this method of determining viscosity can be accurate and reliable.

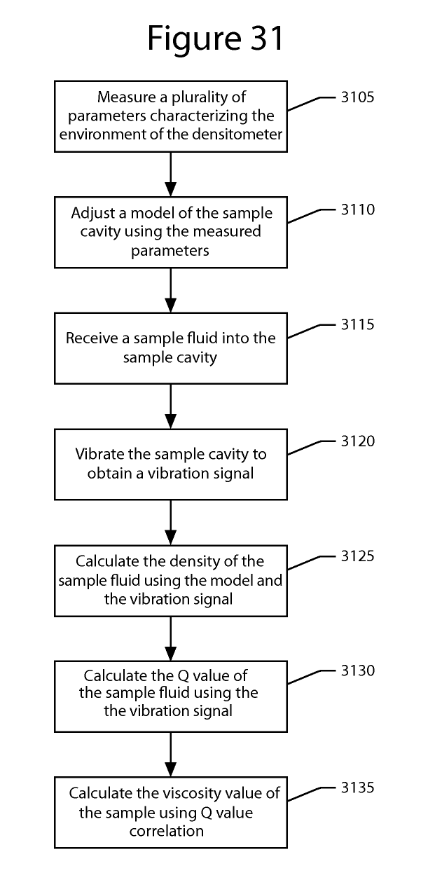

In use, as shown in FIG. 31, the viscosity and density of a fluid are determined using a vibratory resonant densitometer in an environment. The densitometer includes a tubular sample cavity and other densitometer parts. The technique includes measuring a plurality of parameters characterizing the environment (3105). The technique further includes adjusting a model of the sample cavity using the measured parameters (3110). The technique further includes receiving a sample fluid into the sample cavity (3115). The technique further includes vibrating the sample cavity to obtain a vibration signal (3120). The technique further includes calculating the density of the sample fluid using the model and the vibration signal (3125). The technique further includes calculating the Q value of the sample fluid using the vibration signal (3130). The technique further includes calculating the viscosity of the sample fluid using Q value correlations (3135).

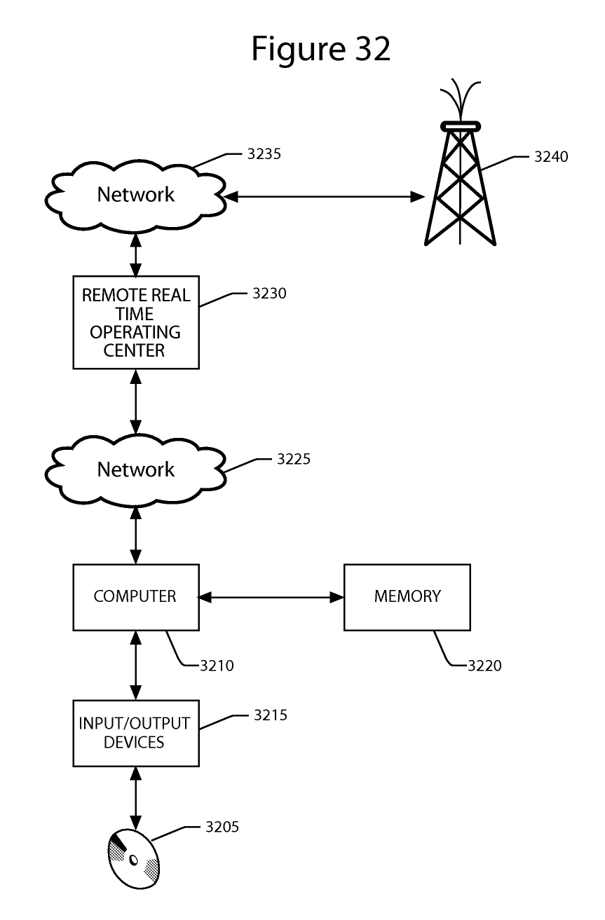

In one embodiment, a computer program for controlling the operation of the measurement device and for performing analysis of the data collected by the measurement device is stored on a computer readable media 3205, such as a CD or DVD, as shown in FIG. 32. In one embodiment a computer 3210, which may be the on the surface or which may be the same as system controller 414, reads the computer program from the computer readable media 3205 through an input/output device 3215 and stores it in a memory 3220 where it is prepared for execution through compiling and linking, if necessary, and then executed. In one embodiment, the system accepts inputs through an input/output device 3215, such as a keyboard, and provides outputs through an input/output device 3215, such as a monitor or printer. In one embodiment, the system stores the results of calculations in memory 3220 or modifies such calculations that already exist in memory 3220.

In one embodiment, the results of calculations that reside in memory 3220 are made available through a network 3225 to a remote real time operating center 3230. In one embodiment, the remote real time operating center makes the results of calculations available through a network 3235 to help in the planning of oil wells 3240 or in the drilling of oil wells 3240. Similarly, in one embodiment, the measurement device can be controlled from the remote real time operating center 3230.

The equipment and techniques described herein are also useful in a logging while drilling (LWD) or measurement while drilling (MWD) environment. They can also be applicable in cased-hole logging and production logging environment to determine fluid or gas density. In general, the equipment and techniques can be used in situations where the in-situ determination of the density of flowing liquid or gas is highly desirable.

The term “logging” refers to a measurement of formation properties with electrically powered instruments to infer properties and make decisions about drilling and production operations. The record of the measurements is called a log.

While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

The various embodiments of the present invention can be joined in combination with other embodiments of the invention and the listed embodiments herein are not meant to limit the invention. All combinations of various embodiments of the invention are enabled, even if not given in a particular example herein.

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A method for determining the density and viscosity of a fluid, comprising:
receiving a fluid sample into a sample tube of a measurement device;
determining a resonant frequency and Q value of the tube containing fluid;
calculating a density of the fluid using the resonant frequency;
calculating a viscosity of the fluid based on the density and Q value.

2. The method of claim 1, wherein the measurement device is a vibrating tube densitometer.

3. The method of claim 2, wherein the vibrating tube densitometer contains vibration source circuits that induce oscillation within a vibrating tube.

4. The method of claim 3, wherein the density and the viscosity of the fluid are calculated utilizing vibration detector circuits that measure oscillation in the vibrating tube densitometer.

5. The method of claim 4, wherein the vibration source circuits comprise electromechanical circuits.

6. The method of claim 4, wherein the vibration source circuits comprise electrical circuits.

7. The method of claim 4, wherein the vibration source circuits induce a time decaying oscillation that the vibration detector circuits record as a function of time and transform into frequency domain to yield a power spectral density from which resonance frequency and the Q value are determined.

8. The method of claim 4, wherein the vibration source circuits induce a variable frequency signal to excite the tube containing fluid into oscillation that the vibration detector circuits record as a function of the induced frequency signal, yielding a power spectral density as a function of the induced frequency signal, from which the resonance frequency and the Q value can be determined.

9. The method of claim 3, wherein a varying frequency drive signal from the vibration source circuits is used to drive the vibrating tube densitometer and a measured response allows a frequency and bandwidth of a resonant peak to be measured.

10. The method of claim 2, wherein a time varying frequency signal from the vibrating tube densitometer allows the resonant frequency to be measured and the Q value to be determined.

11. The method of claim 1, further comprising measuring Q of the fluid and calculating the viscosity of the fluid based on the relationship between Q of the fluid and density of the fluid.

12. The method of claim 1, wherein viscosity (η) of the fluid is determined by using the equation
$$\frac{Q}{ρ} ∝ \frac{1}{\sqrt{ρη}}$$
such that
$$η = \frac{{B}^{2}}{{( Q - A ρ )}^{2}} ,$$
where ρ is density of the fluid and A and B are the intercept and slope of the linear fit of Q/ρ plotted against 1/\sqrt{ρη}.

13. A downhole tool comprising:
a tube that receives a sample fluid having a density;
a rigid pressure housing enclosing said tube and forming an annular area between said tube and said pressure housing;
a vibration source attached to said tube;
at least one vibration detector; and
a measurement module electrically coupled to said vibration source and said vibration detector, wherein the measurement module is configured to measure resonance frequency and Q to determine a density and a viscosity of the sample fluid using frequency and amplitude measurements of the tube;
wherein said vibration source excites the tube containing fluid into oscillation; and
wherein said vibration detector measures such oscillation.

14. The downhole tool of claim 13, wherein the downhole tool is a vibrating tube densitometer.

15. The downhole tool of claim 13, wherein the vibration source comprises circuits that induce oscillation within a vibrating tube.

16. The downhole tool of claim 15, wherein the circuits induce a time decaying oscillation that is recorded as a function of time and transformed into frequency domain to yield a power spectral density from which the Q value can be determined.

17. The downhole tool of claim 15, wherein the circuits induce a variable frequency signal to excite the tube containing fluid into oscillation and the response of the tube is recorded as a function of the induced frequency signal, yielding a power spectral density as a function of the induced frequency signal, from which the Q value is determined.

18. The downhole tool of claim 14, wherein a varying frequency drive signal from the vibrating tube densitometer allows the bandwidth of the resonant peak to be measured.

19. The downhole tool of claim 14, wherein a time decaying amplitude signal allows viscosity to be determined from the measured resonant frequency and Q value of a vibrating tube.

20. The downhole tool of claim 19, wherein viscosity (η) of the fluid is determined by using the equation
$$\frac{Q}{ρ} ∝ \frac{1}{\sqrt{ρη}}$$
such that
$$η = \frac{{B}^{2}}{{( Q - A ρ )}^{2}} ,$$
where ρ is density of the fluid and A and B are the intercept and slope of the linear fit of Q/ρ plotted against 1/\sqrt{ρη}.
